(19) United States
(12) Patent Application Publication
(10) Pub. No.: US 2013/0283361 A1
(43) Pub. Date: Oct. 24, 2013

(54) IDENTITY VERIFICATION

(71) Applicants: Bharath R. Rao, Santa Clara, CA (US); Andrew J. Aftelak, Palatine, IL (US)

(72) Inventors: Bharath R. Rao, Santa Clara, CA (US); Andrew J. Aftelak, Palatine, IL (US)

(73) Assignee: GENERAL INSTRUMENT CORPORATION, Horsham, PA (US)

(21) Appl. No.: 13/453,226

(22) Filed: Apr. 23, 2012

(51) Int. Cl. G06F 21/20; H04L 9/32; G06F 7/04

(52) U.S. Cl. 726/7; 726/9

(57) ABSTRACT

Disclosed are methods and apparatus for providing digital authentication tokens that may be used to verify an identity of a party. A digital authentication token may be determined by iterating a hash function. The input for the first iteration of the hash function may be a function of a password received from a party. Also, a digital authentication token may be determined to be equal to an output of a function composition of a plurality of different hash functions. The argument of the function composition may the function of the password. The function of the password may be performed to increase the entropy of the password. The outputs of the hash functions used may be dependent on (different) salt values.

### FIELD OF THE INVENTION

The present invention relates to digital authentication tokens.

### BACKGROUND OF THE INVENTION

Passwords may be used to protect electronic data in a computer system. For example, a password may be used to validate the identity of a user prior to giving that user access to stored data.

Typically a user's password is stored as a hash value (often referred to as an “authentication token”). The hash value of a password may be determined by first combining the password with a randomly selected bit string called salt. Second, a hash function may be performed on the appended password to compute the hash value. The computed hash value may be stored, along with the salt, in a credential database. The security of the system does not typically depend on the salt being a secret.

The password file or database may fall into the hands of a malicious party, e.g., an attacker or hacker. This may, for example, be due to human error or intrusion. The attacker may perform a variety of attacks on the password data and, with sufficient hardware power, compromise the credential stores.

Hash dictionaries are pre-computed reverse lookups for the most common hashes. Large dictionaries for common hash function values of common passwords exist.

However, hash dictionaries may be too large to store in a computer memory. Hash chains or rainbow tables may be used to reduce the amount of memory required for such storage. Hash chains and rainbow tables use chains of candidate passwords and their hashes and then collapse each chain such that only the endpoints of the chain are stored. If an endpoint of a chain is found by an attacker, then the password may be recovered by replaying the chain's computation.

Salting and Key stretching can greatly reduce the effectiveness of broad-based hash chain or rainbow-table attacks. However, these do not eliminate the possibility of an attacker creating a rainbow table to attack certain accounts. A large salt tends to slow the attacker but tends not to impede the use of rainbow tables.

### BRIEF SUMMARY

The above considerations, and others, are addressed by the present invention, which can be understood by referring to the specification, drawings, and claims. According to aspects of the present invention, methods and apparatus for providing digital authentication tokens that may be used to verify the identity of a party are provided.

In a first aspect, a digital authentication token is determined by iterating a hash function. The input for the first iteration of the hash function is a function of a password (e.g., a password that has been received from the party and is to be used to verify the identity of the party). This function of the password may be a function that increases the entropy of the password, thereby reducing the chances of a successful attack.

The hash function is preferably iterated two or more times. More preferably, the hash function is treated between 4 and 16 times, or between 4 and 8 times, or between 5 and 10 times. Iteration of the hash function as described in more detail below introduces non-determinism into the authentication token. This tends to provide multiple possible hashes for each candidate password, which makes it difficult or impossible for a hacker to store, for example, a hash dictionary, hash chain, or rainbow table that could be used to successfully attack the authentication token.

Methods for verifying the identity of the party, for use with the authentication token that has been determined according to the first aspect, are also provided.

In a second aspect, a digital authentication token is determined to be equal to an output of a function composition of a plurality of different hash functions. The argument of the function composition is a function of the password. The digital authentication token may be determined as follows. First, a first hash function from the plurality may be selected (e.g., randomly or pseudo-randomly). Second, the first hash function may be applied to the function of the password to determine an output value. The remaining hash functions in the plurality may then applied in turn to the output value such that the output of a hash function is the input of the subsequent hash function. The order in which the hash functions are applied may be random or pseudo-random. This repeated application of different hash functions introduces non-determinism into the authentication token.

Methods for verifying the identity of the party, for use with the authentication token determined according to the second aspect, are also provided.

In the first aspect, each iteration of the hash function may be dependent on a (different) salt value. Also, in the second aspect, an output of each of the different hash functions may be dependent on a (different) salt value. These salt values may be determined using some party-dependent data. They may also be computed “on demand” as opposed to being computed and stored. This tends to make it difficult for an attacker to reconstruct the salt values.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a schematic illustration (not to scale) of an example network;

FIG. 2 is a schematic illustration (not to scale) of a client device;

FIG. 3 is a schematic illustration (not to scale) of a server;

FIG. 4 is a process flowchart showing certain steps of a process by which the user may set a username and password;

FIG. 5 is a schematic illustration (not to scale) of a database;

FIG. 6 is a process flowchart showing certain steps of a process of generating an authentication token;

FIG. 7 is a process flowchart showing certain steps of a process in which the user's identity may be validated;

FIG. 8 is a process flowchart showing certain steps of a further process in which the user's identity may be validated;

FIG. 9 is a process flowchart showing certain steps of an identity-verification process that may be performed;

FIG. 10 is a process flowchart showing certain steps of an alternative process of generating an authentication token; and

FIG. 11 is a process flowchart showing certain steps of an alternative identity-verification process.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Apparatus for implementing any of the below described arrangements, and for performing any of the below described method steps, may be provided by configuring or adapting any suitable apparatus, for example one or more computers or other processing apparatus or processors, or providing additional modules. The apparatus may comprise a computer, a network of computers, or one or more processors, for implementing instructions and using data, including instructions and data in the form of a computer program or plurality of computer programs stored in or on a machine-readable storage medium such as computer memory, a computer disk, ROM, PROM, etc., or any combination of these or other storage media.

It should be noted that certain of the process steps depicted in the below described process flowcharts may be omitted or such process steps may be performed in differing order to that presented below and shown in those process flowcharts. Furthermore, although all the process steps have, for convenience and ease of understanding, been depicted as discrete temporally-sequential steps, nevertheless some of the process steps may in fact be performed simultaneously or at least overlapping to some extent temporally.

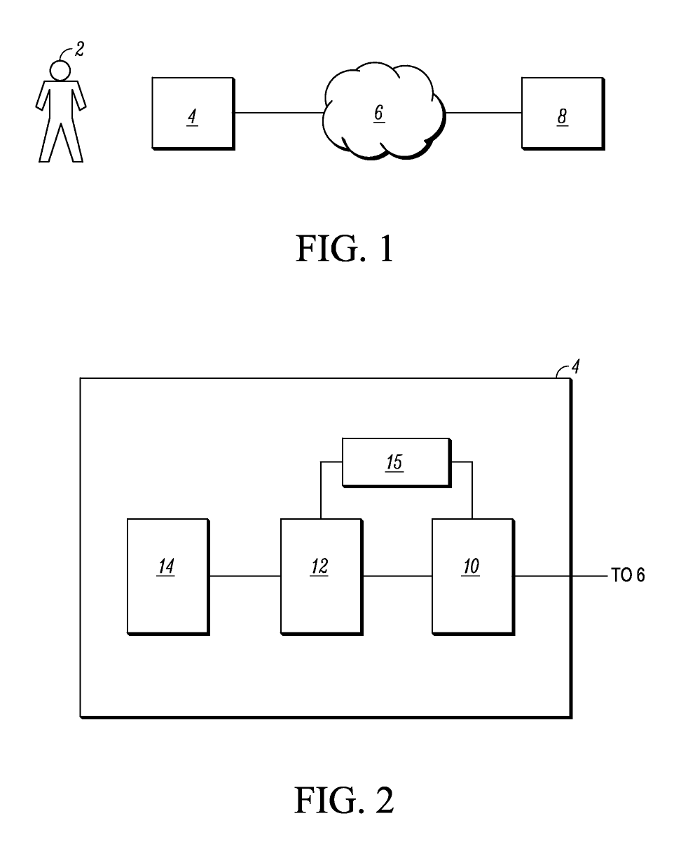

Referring now to the Figures, FIG. 1 is a schematic illustration (not to scale) of an example network 1 in which an embodiment of a method of generating an authentication token is implemented.

The example network 1 comprises a user 2, a client device 4, the Internet 6, and a server 8.

The user 2 is a (human) user of the client device 4. The user 2 may input information into the client device 4.

The client device 4 may, for example, be a computer, e.g., a mobile communications device (e.g., a tablet computer or a so-called “smartphone”). The client device 4 is coupled (e.g., via a wired or wireless link) to the server 8 via the Internet 6. This coupling is such that information may be passed from the client device 4 to the server 8 (via the Internet 6) and vice versa.

FIG. 2 is a schematic illustration (not to scale) of the client device 4.

The client device 4 comprises a first transceiver 10, a first processor 12, a first database 14, and a user interface 15.

The first transceiver 10 is coupled to the Internet 6 such that it may receive information from, and send information to, the server 8. The first transceiver 10 is also coupled to the first processor 12 such that information may be sent from the first transceiver 10 to the first processor 12 and vice versa. The first transceiver 10 is also coupled to the user interface 15 such that information input to the client device 4 by the user 2 via the user interface 15 may be sent to the first transceiver 10, and such that information may be sent from the first transceiver 10 to the user interface 15 (e.g., for display to the user 2).

In addition to being coupled to the first transceiver 10, the first processor 12 is coupled to the first user interface 15 such that information input to the client device 4 by the user 2 via the user interface 15 may be sent to the first processor 12, and such that information may be sent from the first processor 12 to the user interface 15 (e.g., for display to the user 2).

The first processor 12 is configured to generate an authentication token using information input by the user 2 at the user interface 15. The terminology “authentication token” is used herein to refer to a digital (i.e., software) token that is used to verify the identity of the user 2. The authentication token and an embodiment of a process of generating the authentication token are described in more detail below with reference to FIG. 6.

The first processor 12 is coupled to the first database 14 such that a generated authentication token may be stored by the first processor 12 in the first database 14. A stored authentication token may also be retrieved or accessed by the first processor 12.

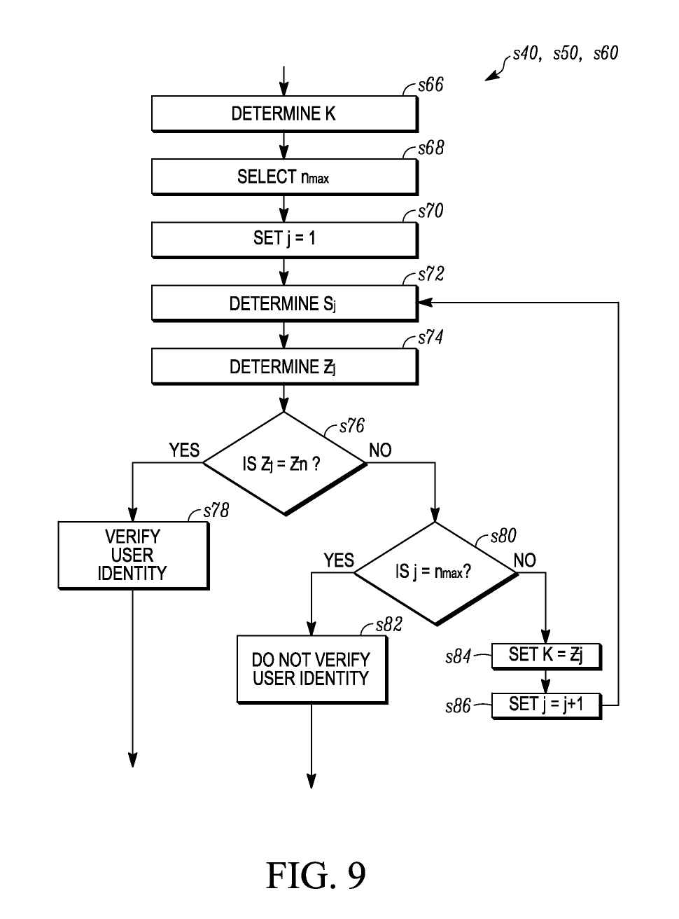

The first processor 12 is further configured to perform an identity-verification process for verifying the identity of the user 2. The identity-verification process is described in more detail below with reference to FIG. 9.

The user interface 15 is a conventional user interface that the user 2 may use to input information into the client device 4. Information may also be displayed to the user 2 using the user interface 15.

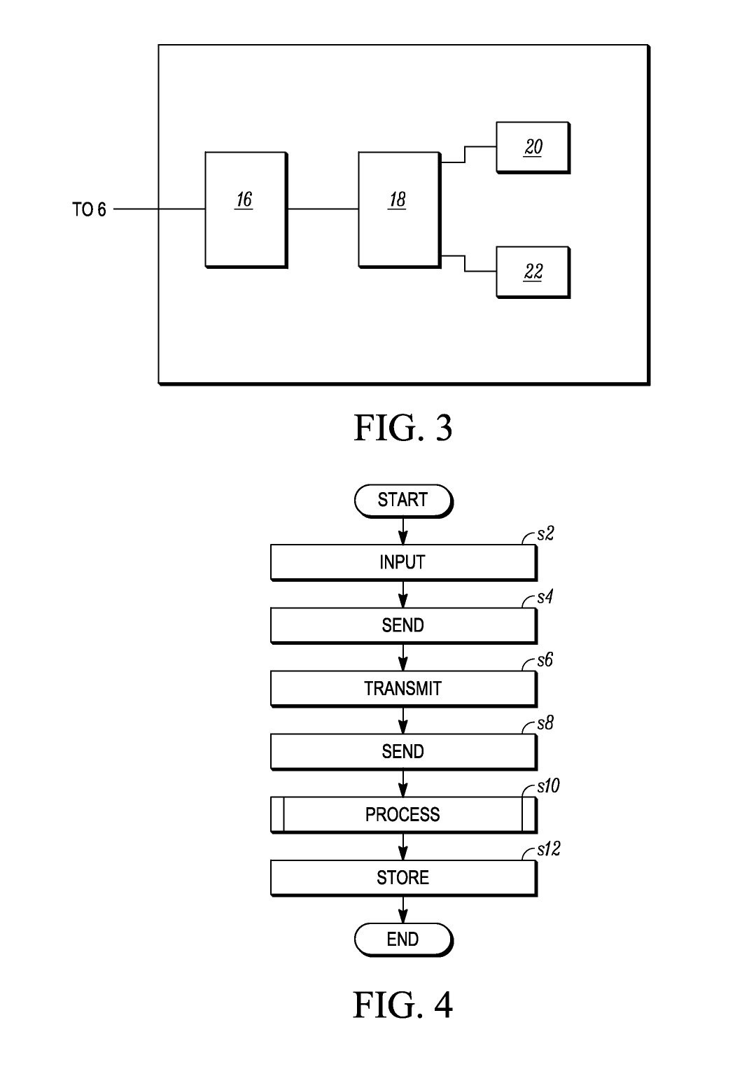

FIG. 3 is a schematic illustration (not to scale) of the server 8.

The server 8 comprises a second transceiver 16, a second processor 18, a second database 20, and a third database 22.

The second transceiver 16 is coupled to the Internet 6 such that it may receive information from, and send information to, the client device 4. The second transceiver 16 is also coupled to the second processor 18 such that information may be sent from the second transceiver 16 to the second processor 18 and vice versa.

The second processor 18 is configured to generate the authentication token using information received from the client device 4, e.g., using the same method that the first processor 12 uses to generate the authentication token, as described in more detail below with reference to FIG. 6.

The second processor 18 is coupled to the second database 20 such that the generated authentication token may be stored by the second processor 18 in the second database 20. A stored authentication token may also be retrieved or accessed by the second processor 18.

The second processor 18 is further configured to perform the identity-verification process for verifying the identity of the user 2. In this embodiment, the identity-verification process performed by the second processor 18 is the same as that performed by the first processor 12. This identity-verification process is described in more detail below with reference to FIG. 9. The second processor 18 is coupled to the third database 22 such that, if the identity of the user 2 is validated (using the authentication process), then the user's access to data stored in the third database 22 is permitted by the second processor 18. For example, data stored on the third database 22 may be sent from the server 8 to the client device 4 for display to the user 2. In other words, if the identity of the user 2 is validated (using the authentication process), the user 2 is allowed access to data stored in the third database 22. However, if the identity of the user 2 is not validated, then the user 2 is not permitted access to data stored on the third database 22. Thus, the second processor 18 in effect controls user access to data stored in the third database 22. Data stored on the second processor 18 may, for example, be the user's personal information and property.

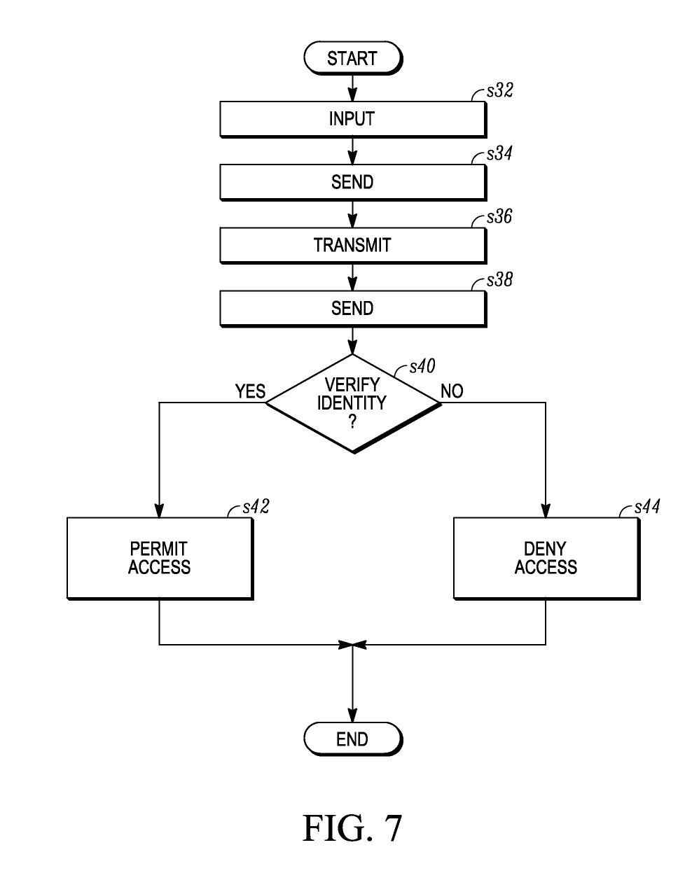

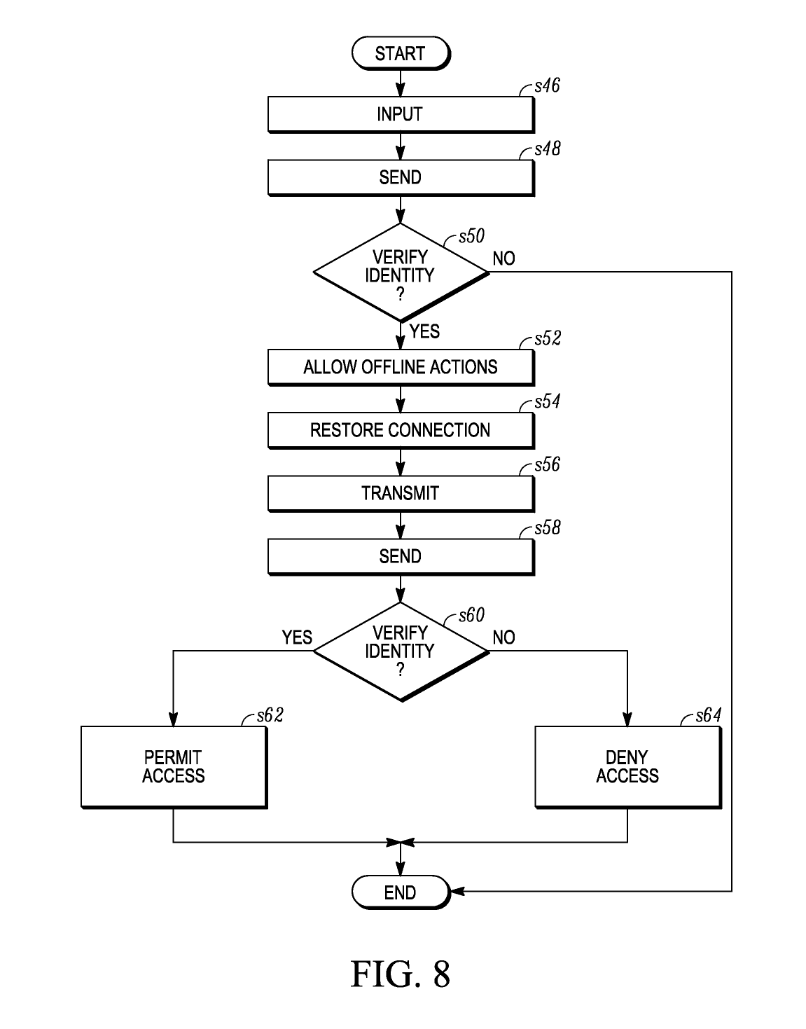

FIG. 4 is a process flowchart showing certain steps of a process by which the user 2 may set a username and password that may be used to verify the user's identity (e.g., by the server 8) at a later time. Example processes in which the user's identity is verified (e.g., to allow the user 2 access to data stored in the third database 22) are described in more detail below with reference to FIGS. 7 and 8.

At step s2, the user 2 inputs a username and a password into the client device 4 using the user interface 15.

At step s4, the username and password are sent to the first transceiver 10 from the user interface 15. Also, at step s4, the username and password are sent to the first processor 12 from the user interface 15.

At step s6, the first transceiver 10 of the client device 4 transmits the username and password, via the Internet 6, to the second transceiver 16 of the server 8. The username and password may be transmitted between the client device 4 and the server 8 in an encrypted form.

At step s8, the second transceiver 16 sends the username and password information to the second processor 18.

At step s10, the first processor 12 and the second processor 18 each process the received username and password to generate a respective authentication token. The process by which the authentication tokens are generated (i.e., the process performed by each of the first and second processors 12, 18) is described in more detail below with reference to FIG. 6. The respective authentication tokens generated by the processors 12, 16 may be the same, or may be different. In other embodiments, an authentication token is generated by only one of the client device 4 or the server 8, and a copy is sent to the other of the client device 4 or the server 8. This may be done so that the authentication tokens stored on the client device 4 and the server 8 are the same.

At step s12, the first processor 12 stores the username and the authentication token it determined in the first database 14. Also at step s12, the second processor 18 stores the username and the authentication token it determined in the second database 20.

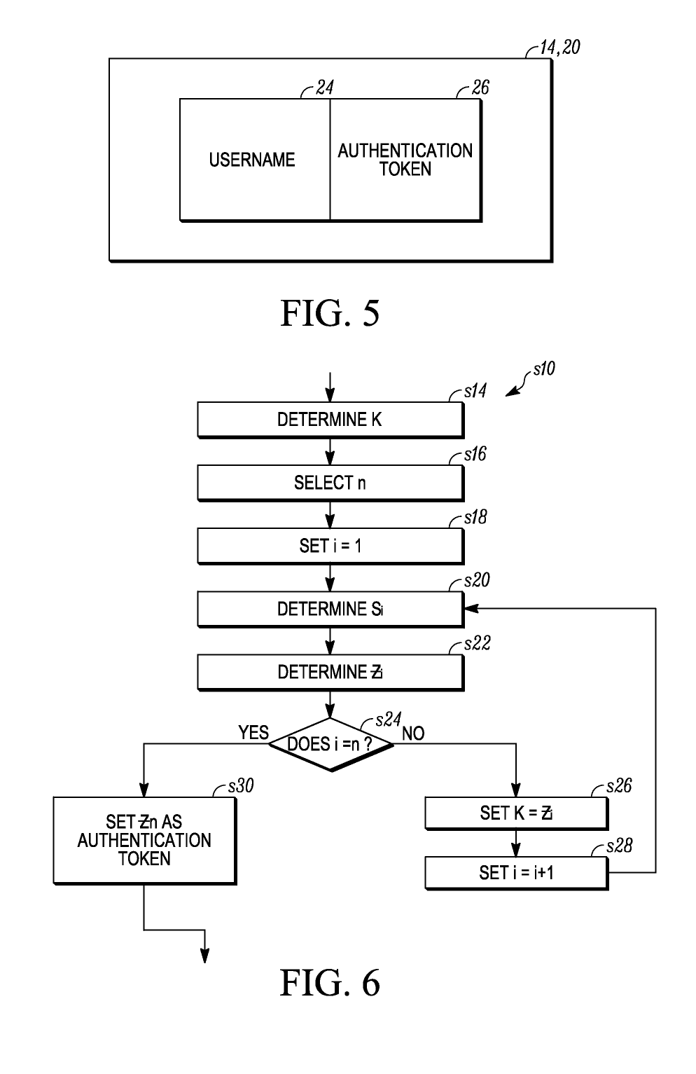

FIG. 5 is a schematic illustration (not to scale) showing the username 24 and the generated authentication token 26 stored in a database (i.e., the first or second database 14, 20). The authentication tokens 26 in the first and second databases 14, 20 may be different from one another.

Thus, a process by which the user 2 may set a username 24 and a password is provided.

FIG. 6 is a process flowchart showing certain steps of a process of generating the authentication token 26 using the username 24 and password provided by the user 2, e.g., as performed by the processors 12, 18 at step s10 of FIG. 4.

The method of FIG. 6 is performed by each of the processors 12, 18 to generate respective authentication tokens.

In this embodiment, the password P of the user 2 is an alphanumeric password comprising any number of characters.

At step s14, the password P is combined with an “entropy string” G. This entropy string G may be a string of alphanumeric characters. The entropy string may comprise any number of characters, e.g., G may be a 128-bit string. Example entropy strings include a 128-bit string of an irrational or transcendental number (e.g., π, \sqrt{π}). This entropy string G increases the entropy of the password P. The entropy string G is, in effect, a global salt and is not, in this embodiment, secret.

A combination function g( ) may be used to combine the password P and the entropy string G. The combination function g( ) may be any appropriate deterministic mathematical function, for example, a cryptographic hash after string concatenation or a bit-interleaving function.

The password P and the entropy string G are combined (using g( )) to form an “enhanced entropy key” K, i.e.,

K=g(P,G)

At step s16, a random number n is selected. The random number n is an integer. Preferably the selected random number n is greater than or equal to 2. More preferably, the random number n is selected from the integers in the range 4 to 16. More preferably, the random number n is selected either from the integers in the range 4 to 8 or from the integers in the range 5 to 10. The first and second processors 12, 18 may select different random numbers, or they may select the same random number.

At step s18, an index i is set equal to 1. The index i is an iteration number.

At step s20, an ith user-specific salt Si is determined using the enhanced entropy key K and the value of the index i. The user-specific salt Si is computed “on demand” as opposed to computing and storing a salt.

The user-specific salt Si may be generated using algorithms that use data associated with the user 2, for example, the username 24, or data selected from a profile of the user 2. The data associated with the user 2 that are used to determine the user-specific salt Si are not stored with the password file (and may not be stored anywhere else).

Advantageously, an attacker attempting to access the user's secure information (e.g., that stored on the third database 22) by reconstructing the user-specific salt Si would tend to need information such as the algorithms and selected criteria selected that have been used to generate the user-specific salt Si for the user 2. Thus, the possibility of successful attack by an attacker tends to be mitigated even if, for example, a password file is gained from the system (e.g., either accidentally or maliciously). The password data may also be stored separately from the rest of the user data. This tends to reduce the chances of an attacker obtaining the information needed to reconstruct the user-specific salt Si. Also, the use of the index i (or other one-time random string or a password-change timestamp, for example) to generate the user-specific salt Si advantageously tends to provide that the same username/password combination generates a different user-specific salt Si for each iteration.

The user-specific salt Si may be generated using any appropriate algorithm or function that, for example, depends on some selected user-related information. The user-specific salt S may be generated using a function of the index i. For example, the user-specific salt S may be computed as follows:

Sᵢ=SHA₂₅₆(U+P+i)

where:
Si is the ith user-specific salt;
SHA₂₅₆ (•) is a conventional cryptographic hash function with a digest that is 256 bits;
U is the username 24;
P is the password; and
i is the index (i.e., the iteration number).

At step s22, an ith hash value Zi is determined using ith user-specific salt Si and the key K.

The hash value Zi may be determined using any appropriate hash function, i.e.,

Zᵢ=h(K,Sᵢ).

At step s24, it is determined whether or not the index i is equal to the selected random number n, i.e., it is determined whether i=n.

If, at step s24, it is determined that i≠n, then the process proceeds to step s26. However, if, at step s24, it is determined i=n, that then the process proceeds to step s30 (which is described in more detail below after a description of steps s26 and s28).

At step s26, the value of the key K is set to be equal to the ith hash value Zi, i.e., K=Zi.

At step s28, the value of the index i is increased by 1, i.e., i=i+1.

After step s28, the process returns to step s20. Thus, steps s20 to s28 of the process of FIG. 6 are performed n times, i.e., until an nth hash value Zn has been generated. At each iteration a new user-specific salt Si is determined. Thus, each iteration tends to use a different salt value. Also, at each iteration, the value of the key K is updated to be equal to the hash value of the previous iteration. Thus, each new hash value is dependent on the previous hash value. In particular:

Zᵢ₊₁=h(Zᵢ,Sᵢ₊ᵢ).

Once it is determined at step s24 that i=n, i.e., n iterations of steps s20 to s28 have been performed to generate an nth hash value Zn, the method proceeds to step s30.

At step s30, the nth hash value Zn is set to be the authentication token 26 and is stored by the processors 12, 18 in the respective databases 14, 20.

Thus, a process of generating an authentication token 26 using the username 24 and password P is provided.

FIG. 7 is a process flowchart showing certain steps of a process in which the user's identity may be validated. The process of FIG. 7 may be carried out whilst there is a connection between the client device 4 and the server 8, i.e., whilst the client device 4 has access to the Internet 6 or is “on-line.” If the user's identity is validated, then access to the data stored in the third database 22 may be allowed. However, if the user's identity is not validated, then access to the data stored in the third database 22 may not be allowed.

During this process the user wishes to gain access to the data stored in the third database 22, e.g., to use or edit that data.

At step s32, the user 2 inputs a username and a password into the client device 4 using the user interface 15. In order to have the user's identity validated, the inputted username and password should be those that have been set by the user 2 using the process of FIG. 4.

At step s34, the username and the password are sent to the first transceiver 10 from the user interface 15.

At step s36, the first transceiver 10 of the client device 4 transmits the username and the password, via the Internet 6, to the second transceiver 16 of the server 8. The username and the password may be transmitted between the client device 4 and the server 8 in an encrypted form.

At step s38, the second transceiver 16 sends the username and the password to the second processor 18.

At step s40, the second processor 18 processes the received username and password to either permit or deny access of the user 2 to the data stored on the third database 22. An identity-verification process is described in more detail below with reference to FIG. 9.

If, at step s40, the user's identity is verified, then the method of FIG. 7 proceeds to step s42. However, if, at step s40, the user's identity is not verified, then the method of FIG. 7 proceeds to step s44.

At step s42, the user's identity has been verified. Thus, the user 2 is allowed access to the data in the third database 22. The user may, for example, use or edit the data stored in the third database 22 or may download some or all of the data, e.g., onto the client device 4.

At step s44, the user's identity has not been verified. Thus, the user 2 is not allowed access to the data in the third database 22. The user 2 may be requested to re-enter his username or password into the user interface 15.

Thus, a process in which the user's identity is verified or otherwise is provided.

FIG. 8 is a process flowchart showing certain steps of a further process in which the user's identity may be validated (or otherwise). The process of FIG. 8 may be carried out whilst there is initially no connection between the client device 4 and the server 8, e.g., whilst the client device 4 initially does not have access to the Internet 6 or is “off-line.”

At step s46, the user 2 inputs a username and a password into the client device 4 using the user interface 15. In order to have the user's identity validated, the inputted username and password should be those set by the user 2 during the process of FIG. 4.

The username and the password may not be sent from the client device 4 to the server 8 because the client device 4 is “off-line.” Instead, at step s48, the username and the password are sent from the user interface 15 to the first processor 12.

At step s50, the first processor 12 processes the received username and password to verify or otherwise the user's identity. An identity-verification process is described in more detail below with reference to FIG. 9.

If at step s50, the user's identity is verified, then the method of FIG. 8 proceeds to step s52.

However, if at step s50, the user's identity is not verified, then the first processor 12 does not allow the user 2 to carry out any off-line actions. At this point the method of FIG. 8 ends. The user 2 may be requested to re-input the username and password.

At step s52, the user's identity has been verified, and the first processor 12 allows the user 2 to perform so called “off-line actions.” The outcome of these actions may be stored by the first processor 12 locally, e.g., on the first database 14.

At step s54, connection of the client device 4 to the server 8 via the Internet 6 is restored. This may for example occur at any time during or after the user 2 performing any offline actions allowed by the first processor 12.

At step s56, the first transceiver 10 of the client device 4 transmits the username and the password, via the Internet 6, to the second transceiver 16 of the server 8. The username and the password may be transmitted between the client device 4 and the server 8 in an encrypted form.

At step s58, the second transceiver 16 sends the username and the password to the second processor 18.

At step s60, the second processor 18 processes the received username and password to either permit or deny access of the user 2 to the data stored on the third database 22. An identity-verification process is described in more detail below with reference to FIG. 9. It may be requested (at step s60) that the user 2 re-enters his username and password, and this re-entered username and password is used, by the second processor 18, to verify the user's identity.

If, at step s60, the user's identity is verified, then the method of FIG. 8 proceeds to step s62. However, it, at step s60, the user's identity is not verified, then the method of FIG. 8 proceeds to step s64.

At step s62, the user's identity has been verified. Thus, the second processor 18 allows the data in the third database 22 to be processed in accordance with the off-line actions that were performed by the user 2 and were stored by the first processor 12 locally, e.g., on the first database 14.

At step s64, the user's identity has not been verified. Thus, access to the data in the third database 22 is not allowed. The user may be requested to re-enter his username or password into the user interface 15.

Thus, a further process in which the user's identity is verified or otherwise is provided.

FIG. 9 is a process flowchart showing certain steps of an identity-verification process that may be performed by the first or second processor 12, 18 to verify (or otherwise) the identity of the user 2 (for example, as performed at step s40 of FIG. 7 and steps s50 and s60 of FIG. 8).

At step s66, the password P provided by the user 2 is combined with the entropy string G using the combination function go (i.e., as performed at step s14 of FIG. 6). This forms an enhanced entropy key K.

At step s68, an integer that is greater than or equal to the maximum that n could be is selected. For example, if, at step s16 of FIG. 6, n was randomly selected from the integers in the range 4 to 16, at step s68, a number greater than or equal to 16 is selected. This number is referred to hereinafter as nmax. Preferably, nmax is equal to the maximum that n could be.

At step s70, an index j is set equal to 1. The index j is an iteration number.

At step s72, the jth user-specific salt Sj is determined using the enhanced entropy key K and the value of the index j. The user-specific salt Sj is computed “on demand” as opposed to computing and storing a salt. The user-specific salt Sj is generated in the same way as performed at step s20 of FIG. 6.

At step s74, a jth hash value Zj is determined using the jth user-specific salt Sj and the key K. The jth hash value Zj is determined in the same way as performed at step s22 of FIG. 6.

At step s76, it is determined whether or not the received username and the jth hash value Zj are the same as the username 24 and the authentication token 26 stored in the relevant database. In other words, if the identity-verification process of FIG. 9 is being performed by the first processor 12, then at step s76 it is determined whether or not the received username and the jth hash value Zj are the same as the username 24 and the authentication token 26 stored in the first database 14. Likewise, if the identity-verification process of FIG. 9 is being performed by the second processor 18, then at step s76 it is determined whether or not the received username and the jth hash value Zj are the same as the username 24 and the authentication token 26 stored in the second database 20.

If, at step s76, it is determined that the received username and the jth hash value Zj are the same as the stored username 24 and the authentication token 26, then the method of FIG. 9 proceeds to step s78. However, if, at step s76, it is determined that the received username and the jth hash value Zj are not the same as the stored username 24 and the authentication token 26, then the method of FIG. 9 proceeds to step s80 (which is described below after a description of step s78).

At step s78, it has been determined that the received username and the jth hash value Zj are the same as the stored username 24 and authentication token 26. Thus, it is determined that the username and password provided by the user 2 are the same as those set by the user 2 during the process of FIG. 4. Thus, the user's identity is verified.

At step s80, it is determined whether or not the index j is equal to the selected number nmax, i.e., it is determined whether j=nmax.

If, at step s80, it is determined that j=nmax, then the process proceeds to step s82. However, if, at step s64, it is determined that j≠nₘₐₓ, then the process proceeds to step s84 (which is described in more detail below after a description of step s82).

At step s82, it has been determined that the received username and each of the 1st to the nmaxth hash values (Z1 to Znmax) have not been the same as the stored username 24 and authentication token 26. Thus, it is determined that the username and password provided by the user 2 are not the same as those set by the user 2 during the process of FIG. 4. Thus, the user's identity is not verified. The user 2 may be requested to input his username and password again.

At step s84, the value of the key K is set to be equal to the jth hash value Zj, i.e., K=Zj.

At step s86, the value of the index j is increased by 1, i.e., j=j+1.

After step s86, the process returns to step s72. Thus, steps s72 to s86 of the process of FIG. 9 are iterated until either the user's identity is verified or until each of the hash values Z1 to Znmax have been computed and compared to the stored authentication token 26.

Thus, an identity-verification process is provided.

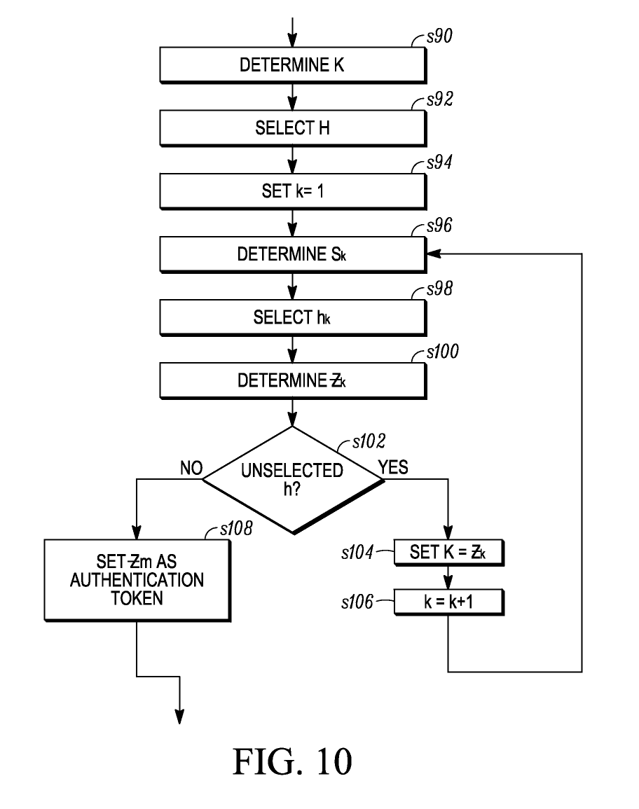

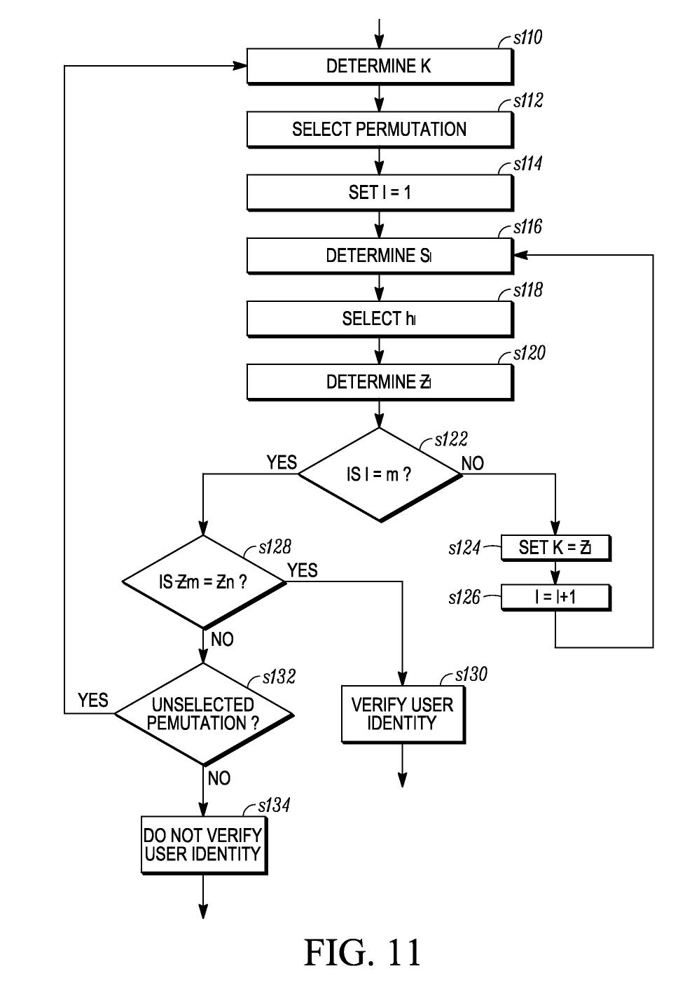

In the above embodiments, respective authentication tokens 26 are determined by the processors 12, 18 (e.g., at step s10) using the process described above with reference to FIG. 6 (i.e., by performing steps s14 to s30). However, in other embodiments, a different process of determining an authentication token may be used. For example, the alternative process described below with reference to FIG. 10 may be used. In such embodiments, an alternative identity-verification process may be used to verify the identity of the user 2. For example, the alternative identity-verification process described below with reference to FIG. 11 may be used.

FIG. 10 is a process flowchart showing certain steps of an alternative process of generating an (alternative) authentication token using the username and password provided by the user. This process may be used in place of the process of FIG. 6 in other embodiments.

In this embodiment, the password P of the user 2 is an alphanumeric password comprising any number of characters.

At step s90, the received password P is combined with the entropy string G using the combination function go. Thus, an enhanced entropy key K is generated. This may be performed as described above with reference to step s14 of FIG. 6.

At step s92, a set H of hash functions is selected. The set H comprises a predetermined number of different hash functions h₁ (•), . . . , hₘ(•), where m is a predetermined (known) number. Preferably, m may be between 3 and 10. For example, the set H may consist of five different hash functions, e.g.,

H={SHA₂₂₄(•),SHA₂₅₆(•),SHA₃₈₄(•),SHA₅₁₂(•),md5(•)}
where: SHA₂₂₄(•), SHA₂₅₆(•), SHA₃₈₄(•), SHA₅₁₂(•) are conventional cryptographic hash functions with digests of 224, 256, 384, and 512 bits respectively; and md5(•) is a conventional message digest algorithm.

At step s94, an index k is set equal to 1. The index k is an iteration number.

At step s96, the kth user-specific salt Sk is determined using the enhanced entropy key K and the value of the index k. The user-specific salt Sk is computed as described above with reference to step s20 of FIG. 6.

At step s98, a previously unselected hash function hk is selected at random from the group of hash functions H.

At step s100, a kth hash value Zk is determined using kth user-specific salt Sk, the key K, and the hash function hk (that was selected randomly at step s98).

The kth hash value Zi may be determined as:

Zₖ=hₖ(K,Sₖ).

At step s102, it is determined whether or not there are any as yet unselected hash functions in the group of hash functions H. Equivalently, it may be determined whether or not k=m.

If, at step s102, it is determined that there are one or more as yet unselected hash functions in the group of hash functions H, then the process proceeds to step s104. However, if at step s112 it is determined that there are no unselected hash functions in the group of hash functions H, then the process proceeds to step s108, which is described below after the description of steps s104 and s106.

At step s104, the value of the key K is set to be equal to the kth hash value Zk.

At step s106, the value of the index k is increased by 1.

After step s106, the process returns to step s96. Thus, steps s96 to s106 of the process of FIG. 10 are iterated until each hash function in the group of hash functions has been selected and used. At each iteration a new user-specific salt Si is determined. Thus, each iteration tends to use a different salt value. Also, at each iteration, the value of the key K is updated to be equal to the hash value of the previous iteration. Thus, each new hash value is dependent on the previous hash value. In particular:

Zₖ₊₁=hₖ₊₁(Zₖ,Sₖ₊₁).

Once it is determined at step s102 that each of the hash functions in the group H has been used, the method proceeds to step s108.

At step s108, the latest hash value Zm is set to be the authentication token 26 and is stored by a processor 12, 18 in a respective database 14, 20.

Thus, an alternative process of generating an alternative authentication token 26 using the username 24 and password P is provided.

FIG. 11 is a process flowchart showing certain steps of an alternative identity-verification process that may be performed by a processor 12, 18, e.g., at step s40, s50, or s60. This alternative identity-verification process may be used when the authentication token has been determined using the process of FIG. 10.

At step s110, the password P is combined with the entropy string G using the combination function go. Thus, an enhanced entropy key K is generated. This may be performed as described above with reference to step s14 of FIG. 6.

At step s112, a previously unselected permutation of the m hash functions h (from the set of hash functions H) is selected. The set H of hash functions is the known set of hash functions h₁(•), . . . , hₘ(•) used by the processors 12, 18 at step s92 of FIG. 10.

At step s114, an index l is set equal to 1. The index l is an iteration number.

At step s116, the lth user-specific salt Sl is determined using the enhanced entropy key K and the value of the index l. The user-specific salt Sl is computed as described above with reference to step s20 of FIG. 6.

At step s118, the lth hash function hl in the permutation of hash functions (selected at step s112) is selected.

At step s120, an lth hash value Zl is determined using lth user-specific salt Sl, the key K, and the hash function hl. The lth hash value Zl is computed as described above with reference to step s100 of FIG. 10, i.e., as Zl=hl(K, Sl).

At step s122, it is determined whether or not l=m (i.e., whether each hash function h in the currently selected permutation of hash functions has been selected).

If, at step s122, it is determined that l≠m, then the process proceeds to step s124. However, if at step s122 it is determined that l=m, then the process proceeds to step s128, which is described below after the description of steps s124 and s126.

At step s124, the value of the key K is set to be equal to the lth hash value Zl.

At step s126, the value of the index l is increased by 1.

After step s126, the process returns to step s116. Thus, steps s116 to s126 of the process of FIG. 11 are iterated until each hash function in the selected permutation of hash functions has been selected and used.

Once it is determined at step s122 that l=m, i.e., that each of the hash functions in the selected permutation of hash functions has been used, the method proceeds to step s128.

At step s128, it is determined whether or not the received username and the latest hash value Zm are the same as the username 24 and the authentication token 26 stored in the relevant database.

If, at step s128, it is determined that the received username and the latest hash value Zm are the same as the stored username 24 and the authentication token 26, then the method of FIG. 11 proceeds to step s130. However, if, at step s128, it is determined that the received username and the latest hash value Zm are not the same as the stored username 24 and the authentication token 26, then the method of FIG. 11 proceeds to step s132 (which is described below after a description of step s130).

At step s130, it has been determined that the received username and the latest hash value are the same as the stored username 24 and authentication token 26. Thus, it is determined that the username and password provided by the user 2 are the same as those set by the user 2 during the process of FIG. 4. Thus, the user's identity is verified.

At step s132, it is determined whether or not every permutation of the m hash functions in the set H has been used to compute an mth hash value Zm (i.e., whether or not the hash value Zm has been determined for each permutation of the m hash values).

If, at step s132, it is determined that every permutation of the m hash functions in the set H has been used, then the process proceeds to step s134. However, if, at step s132, it is determined that not every permutation of the m hash functions in the set H has been used, then the process returns to s110. At this point, the identity-verification process is re-performed, this time using a permutation of hash functions h that has not yet been selected.

Thus, steps s110 to s132 are performed until either the user's identity is verified, or until every permutation of the m hash functions has been tested.

At step s134, it has been determined that the received username and any of the hash values Zm (for all permutations of the m hash functions h) have not been the same as the stored username 24 and authentication token 26. Thus, it is determined that the username and password provided by the user 2 are not the same as those set by the user 2 during the process of FIG. 4. Thus, the user's identity is not verified. The user 2 may be requested to input his username and password again.

Thus, an alternative identity-verification process (that may be used when the authentication token has been determined using the process of FIG. 10) is provided.

An advantage provided by the above described methods and apparatus is that an effectively non-reversible representation of the user's password (i.e., the authentication token) is generated. This authentication token tends to be resistant to so-celled “brute force” attacks or hacks.

Online authentication of the user's identity may advantageously be provided for using the authentication token generated by and stored on the server.

Offline authentication of the user's identity may also advantageously be provided for, e.g., by the client device creating and storing an authentication token (using the same algorithm as the server). Offline authentication may alternatively be provided for by the server sending the authentication token that it generated to the client device, for storage and use by the client device during offline authentication. Online authentication may advantageously be requested, e.g., if after or during the performance of offline actions, the client device re-connects to the server. This advantageously tends to ensure that the user credentials have not been revoked before the client can commit any changes to the server.

The above described method may be used by a (mobile) client device to verify a user's identity without any interaction with a remote. Similarly, the above described method may be used by a server to verify a user's identity without any interaction with a (mobile) client device.

In the above methods, each user-specific salt is generated using algorithms that use user data. The salts (and algorithms used to generate the salts) are not stored with the password file (or anywhere else). Thus, any attacker would tend to need additional information (such as the algorithms and criteria selected to generate the user salt for each individual user) to perform a successful attack. Thus, a possibility of a successful attack being performed (e.g., if the password file is leaked out of the system accidentally or maliciously) tends to be reduced or eliminated.

Optionally, any password data may be stored separately from other user data. This advantageously tends to reduce the chances of an attacker obtaining the information needed to reconstruct the salt.

Optionally, a one-time random string or a password change timestamp may be used as an input to generate a user-specific salt. This advantageously tends to ensure the same user/password combination generates a different salt at each algorithm iteration. Thus, the chances of a successful attack tend to be reduced further.

During the generation of an authentication token, multiple hashes are performed (e.g., the same hash function may be iteratively implemented, or multiple different hashes may be used such that an output of one hash function is used as an input for the subsequent hash function). This advantageously tends to increase (e.g., exponentially) the size of a hash dictionary, hash chain, or rainbow table that an attacker needs to perform a brute force attack on the authentication token.

In particular, an entropy enhanced key K and a user-specific salt S are combined and hashed to generate a relatively strong (i.e., resistant to attack) hash value Z (Z=h(K, S), which itself may be repeatedly hashed. The repeated hashing tends to increase computational load and introduce non-determinism into the authentication token (i.e., the ultimate hash value that is stored). This tends to provide that there are multiple possible hashes for each candidate password. In particular, the number of possible hashes for a candidate password tends to increase exponentially with the number of iterations. The collapsing of this hash structure (e.g., as performed for hash chains and rainbow tables to reduce storage requirements) tends not to result in space savings. Thus, it tends to be difficult or impossible for a hacker to store a hash dictionary, hash chain, or rainbow table that could be used to successfully attack the authentication token.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method of providing a digital authentication token, the method comprising:
receiving, by a receiving module, a password;
iterating, by a processor operatively coupled to the receiving module, a hash function, the iteration of the hash function being performed a number of times, the number of times being greater than or equal to two; and
storing as the digital authentication token, in a storage operatively coupled to the processor, an output of the iteration;
wherein an argument of the first iteration of the hash function is a function of the password.

2. A method according to claim 1 wherein an output of each iteration of the hash function is dependent on a respective salt value.

3. A method according to claim 2 wherein the respective salt values upon which each of the outputs are dependent upon are different salt values.

4. A method according to claim 1 wherein the function of the password that is the argument of the first iteration of the hash function is a combination of the password and an entropy string.

5. A method according to claim 1 wherein the number of times that the hash function is iterated is randomly or pseudo-randomly selected from a set of integers, each integer in the set of integers being greater than or equal to 2.

6. A method according to claim 5 wherein the set of integers is a set selected from the group of sets consisting of: a set comprising the integers between 4 and 16, a set comprising the integers between 4 and 8, and a set comprising the integers between 5 and 10.

7. A method of verifying the identity of a party, the method comprising:
providing a digital authentication token;
receiving, by a receiving module, a password;
iterating, by a processor operatively coupled to the receiving module, a hash function, the iteration of the hash function being performed a number of times, the hash function being a same hash function as that used to determine the authentication token, an argument of the first iteration of the hash function being a function of the received password;
comparing the output of each iteration of the hash function to the digital authentication token; and
depending on the comparison of the outputs of each iteration of the hash function with the digital authentication token, verifying or not verifying the identity of a party.

8. A method according to claim 7 wherein the step of, depending on the comparison of the outputs of each iteration of the hash function with the digital authentication token, verifying or not verifying the identity of a party comprises:
if an output of an iteration of the hash function is the same as the digital authentication token, verifying the identity of a party; and
if the output of each of the iteration of the hash function is different from the digital authentication token, not verifying the identity of a party.

9. A method of providing a digital authentication token, the method comprising:
receiving, by a receiving module, a password;
providing a plurality of different hash functions;
determining, by a processor operatively coupled to the receiving module, the digital authentication token, the digital authentication token being equal to an output of a function composition of the plurality of different hash functions, an argument of the function composition being a function of the password; and
storing as the digital authentication token, in a storage operatively coupled to the processor, the output of the function composition.

10. A method according to claim 9 wherein the step of determining the digital authentication token comprises:
providing, as an input, the function of the password; and
repeatedly performing steps (i) to (iii) until there are no hash functions that have not been selected, wherein step (i) comprises selecting, from the plurality, a hash function that has not previously been selected, wherein step (ii) comprises determining a hash value by applying the currently selected hash function to the current input, and wherein step (iii) comprises setting, as the input, the determined hash value; and
setting, as the digital authentication token, the value of the input after steps (i) to (iii) have been repeatedly performed until there are no hash functions that have not been selected.

11. A method according to claim 10 wherein step (i) comprises randomly or pseudo-randomly selecting, from the plurality, a hash function that has not previously been selected.

12. A method according to claim 9 wherein an output of each of the different hash functions is dependent on a salt value.

13. A method according to claim 12 wherein the salt values upon which the outputs are dependent are different salt values.

14. A method according to claim 9 wherein the function of the password that is the argument of the function composition is a combination of the password and an entropy string.

15. A method of verifying the identity of a party, the method comprising:
providing a digital authentication token;
receiving, by a receiving module, a password;
providing a plurality of different hash functions, the plurality of different hash functions being the same as those used to provide the authentication token;
determining, by a processor iteratively coupled to the receiving module, one or more values, each value being equal to an output of a different respective function composition of the plurality of different hash functions, an argument of each of the different function compositions being a function of the password;
comparing each determined value to the digital authentication token; and
depending on the one or more comparisons, verifying or not verifying the identity of a party.

16. A method according to claim 15 wherein the step of, depending on the one or more comparisons, verifying or not verifying the identity of a party comprises:
if a value is the same as the digital authentication token, verifying the identity of a party; and
if each of the one or more values is different to the digital authentication token, not verifying the identity of a party.
